(19) United States
(12) Patent Application Publication
(10) Pub. No.: US 2013/0301312 A1
(43) Pub. Date: Nov. 14, 2013

(54) ISOLATED SWITCHING POWER SUPPLY APPARATUS

(71) Applicant: Murata Manufacturing Co., Ltd., Nagaokakyo-shi (JP)

(72) Inventors: Masanori KONISHI, Nagaokakyo-shi (JP); Takayoshi NISHIYAMA, Nagaokakyo-shi (JP)

(21) Appl. No.: 13/946,172

(22) Filed: Jul. 19, 2013

Related U.S. Application Data
(63) Continuation of application No. PCT/JP2012/050304, filed on Jan. 11, 2012.

(30) Foreign Application Priority Data
Feb. 7, 2011 (JP) 2011-023730

(51) Int. Cl. H02M 3/335

(52) U.S. Cl. CPC H02M 3/33507
USPC 363/21.15

(57) ABSTRACT

An isolated switching power supply apparatus includes a transformer, a primary-side circuit that includes at least a switching element and supplies input power from an input terminal to a primary winding by controlling on/off of the switching element, and a secondary-side circuit that is electrically isolated from the primary-side circuit and that outputs output power resulting from power conversion performed by the transformer from a secondary winding to an output terminal. The apparatus includes a first circuit board to which the primary winding is connected and that includes the primary-side circuit and the input terminal, and a second circuit board to which the secondary winding is connected and that includes the secondary-side circuit and the output terminal. The first and second circuit boards are stacked in a multilayer manner. The primary and secondary windings are arranged around a core that extends through the first and second circuit boards.

### BACKGROUND OF THE INVENTION

1. Field of the Invention

The present invention relates to an isolated switching power supply apparatus and particularly to an isolated switching power supply apparatus that includes a transformer.

2. Description of the Related Art

A switching power supply module disclosed in Japanese Unexamined Patent Application Publication No. 2004-222486 includes a plurality of circuit boards, on each of which a power conversion circuit is formed. The plurality of circuit boards are stacked in a multilayer manner with a gap therebetween. Moreover, along edge portions of each of the plurality of circuit boards, a plurality of conductive land patterns are arranged with a predetermined gap therebetween. The conductive land patterns arranged on the circuit boards are connected by common terminals made of a conductive material. At least one of the common terminals has a leg portion that functions as a component for external connection and that extends in the stacking direction of the circuit boards.

A switching power supply apparatus disclosed in International Publication No. 2007/069403 includes a transformer that performs power conversion. The transformer includes a core that extends in through openings formed in a printed circuit board and a coil pattern formed around a through opening formed in the printed circuit board.

The switching power supply module disclosed in Japanese Unexamined Patent Application Publication No. 2004-222486 has a structure in which a plurality of circuit boards are stacked in a multilayer manner and, for each of the circuit boards, a power conversion circuit unit is formed on the circuit board. That is, there is an issue in that the manufacturing cost is increased because a plurality of identical circuits are provided in one module. Moreover, in order to make current flow in the power conversion circuit units formed on the plurality of circuit boards, it is necessary to make a large current flow through the common terminals that connect the conductive land patterns arranged on the plurality of circuit boards. There is an issue in that current loss is increased in the switching power supply module.

In the switching power supply apparatus disclosed in International Publication No. 2007/069403, primary-side and secondary-side windings of the transformer are formed on the same printed circuit board. Thus, strong coupling occurs due to the mutual inductance between the primary-side winding and the secondary-side winding and there is a small amount of leakage inductance. In order to increase the amount of leakage inductance and use the leakage inductance for circuit operation, it has been necessary to specially design the primary-side or secondary-side winding such that the size of the coil pattern of the primary-side or secondary-side winding is increased, the coil pattern is made complex, or the like.

### SUMMARY OF THE INVENTION

In view of such circumstances, preferred embodiments of the present invention provide, at a low manufacturing cost, an isolated switching power supply apparatus that significantly reduces current loss.

An isolated switching power supply apparatus according to a preferred embodiment of the present invention includes a transformer that includes a primary winding, a secondary winding, and a core; a primary-side circuit that includes at least a switching element and supplies input power from an input terminal to the primary winding by controlling on/of of the switching element; and a secondary-side circuit that is electrically isolated from the primary-side circuit and outputs, from the secondary winding to an output terminal, output power resulting from power conversion performed by the transformer. The isolated switching power supply apparatus includes a first circuit board to which the primary winding is connected and that includes the primary-side circuit and the input terminal, and a second circuit board to which the secondary winding is connected and that includes the secondary-side circuit and the output terminal. The first circuit board and the second circuit board are stacked in a multilayer manner, and the core extends through the first circuit board and the second circuit board such that both the primary winding and the secondary winding are arranged around the core.

In the above-described structure, the first circuit board and the second circuit board are included. The first circuit board, to which the primary winding is connected, includes the primary-side circuit and the input terminal. The second circuit board, to which the secondary winding is connected, includes the secondary-side circuit and the output terminal. The first circuit board and the second circuit board are stacked in the multilayer manner. The core extends through the first circuit board and the second circuit board such that the primary winding and the secondary winding are arranged around the core. Thus, there is no need to redundantly provide identical circuits on both the first circuit board and the second circuit board, and consequently, the manufacturing cost may be reduced. Moreover, since the input terminal is provided on the first circuit board and the output terminal is provided on the second circuit board, a common terminal that connects patterns located on the first circuit board and the second circuit board is not necessary. It is not necessary to make a large current flow through a common terminal, and consequently, current loss may be reduced in the isolated switching power supply apparatus.

Moreover, it is desirable that, in the isolated switching power supply apparatus according to a preferred embodiment of the present invention, a distance between the primary winding and the secondary winding is changed by changing a distance between the first circuit board and the second circuit board, which are stacked in the multilayer manner, and consequently, the amount of leakage inductance occurring in the transformer is changed, and the leakage inductance occurring in the transformer is used as the inductance of an inductor connected in series with the primary winding or the secondary winding.

With the above-described structure, the distance between the primary winding and the secondary winding is changed by changing the distance between the first circuit board and the second circuit board, which are stacked in the multilayer manner. Consequently, the amount of leakage inductance occurring in the transformer is changed. There is no need to mount an additional inductor on the first circuit board or on the second circuit board since the leakage inductance is used as the inductance of an inductor connected in series with the primary winding or the secondary winding. Thus, the number of components used may be reduced. In the case where the primary winding and the secondary winding are defined by coil patterns, in order to make leakage inductance occur in the transformer, there is no need to specially design the primary winding or the secondary winding such that the size of the coil pattern is increased, the coil pattern is made complex, or the like.

Moreover, it is desirable that the isolated switching power supply apparatus according to a preferred embodiment of the present invention include a spacer that defines the distance between the first circuit board and the second circuit board, which are stacked in the multilayer manner.

In the above-described structure, the spacer is included, which defines the distance between the first circuit board and the second circuit board, which are stacked in the multilayer manner. Thus, the distance between the first circuit board and the second circuit board, which are stacked in the multilayer manner, may be easily changed so as to make the amount of leakage inductance occurring in the transformer be a desired amount.

Moreover, it is desirable that, in the isolated switching power supply apparatus according to a preferred embodiment of the present invention, the primary winding be defined by a coil pattern on the first circuit board and the secondary winding be defined by a coil pattern on the second circuit board.

In the above-described structure, the primary winding is defined by a coil pattern on the first circuit board and the secondary winding is defined by a coil pattern on the second circuit board. Thus, there is no need to mount an additional coil as a winding on the first circuit board or the second circuit board.

Moreover, it is desirable that, in the isolated switching power supply apparatus according to a preferred embodiment of the present invention, components of the primary-side circuit be arranged on a surface, which is the farthest surface from the surface facing the second circuit board, of the first circuit board and components of the secondary-side circuit be arranged on a surface, which is the farthest surface from the surface facing the first circuit board, of the second circuit board.

In the above-described structure, the components of the primary-side circuit are arranged on the surface, which is the farthest surface from the surface facing the second circuit board, of the first circuit board. The components of the secondary-side circuit are arranged on the surface, which is the farthest surface from the surface facing the first circuit board, of the second circuit board. Thus, the first circuit board is arranged to approach the second circuit board at a position where the first circuit board contacts the second circuit board. Consequently, the distance between the first circuit board and the second circuit board, which are stacked in the multilayer manner, may be changed so as to be in a wider range. As a result, the amount of leakage inductance occurring in the transformer may be changed so as to be in a wider range.

With the above-described structure, the first circuit board and the second circuit board are included. The first circuit board, to which the primary winding is connected, includes the primary-side circuit and the input terminal. The second circuit board, to which the secondary winding is connected, includes the secondary-side circuit and the output terminal. The first circuit board and the second circuit board are stacked in the multilayer manner. The core extends through the first circuit board and the second circuit board such that the primary winding and the secondary winding are arranged around the core. Thus, there is no need to redundantly provide identical circuits on both the first circuit board and the second circuit board, and consequently, the manufacturing cost may be reduced. Moreover, since the input terminal is provided on the first circuit board and the output terminal is provided on the second circuit board, a common terminal that connects patterns located on the first circuit board and the second circuit board is not necessary. It is not necessary to make a large current flow through a common terminal, and consequently, current loss may be reduced in the isolated switching power supply apparatus.

The above and other elements, features, steps, characteristics and advantages of the present invention will become more apparent from the following detailed description of the preferred embodiments with reference to the attached drawings.

### BRIEF DESCRIPTION OF THE DRAWINGS

FIG. 1 is a circuit diagram illustrating the circuit structure of an isolated switching power supply apparatus according to a first preferred embodiment of the present invention.

FIG. 2 is a schematic diagram illustrating the structure of the isolated switching power supply apparatus according to the first preferred embodiment of the present invention.

FIG. 3 is a circuit diagram illustrating another circuit structure of the isolated switching power supply apparatus according to the first preferred embodiment of the present invention.

FIG. 4 is a schematic diagram illustrating the structure of an isolated switching power supply apparatus according to a second preferred embodiment of the present invention.

### DETAILED DESCRIPTION OF THE PREFERRED EMBODIMENTS

In the following, preferred embodiments of the present invention will be described in detail with reference to the drawings.

### First Preferred Embodiment

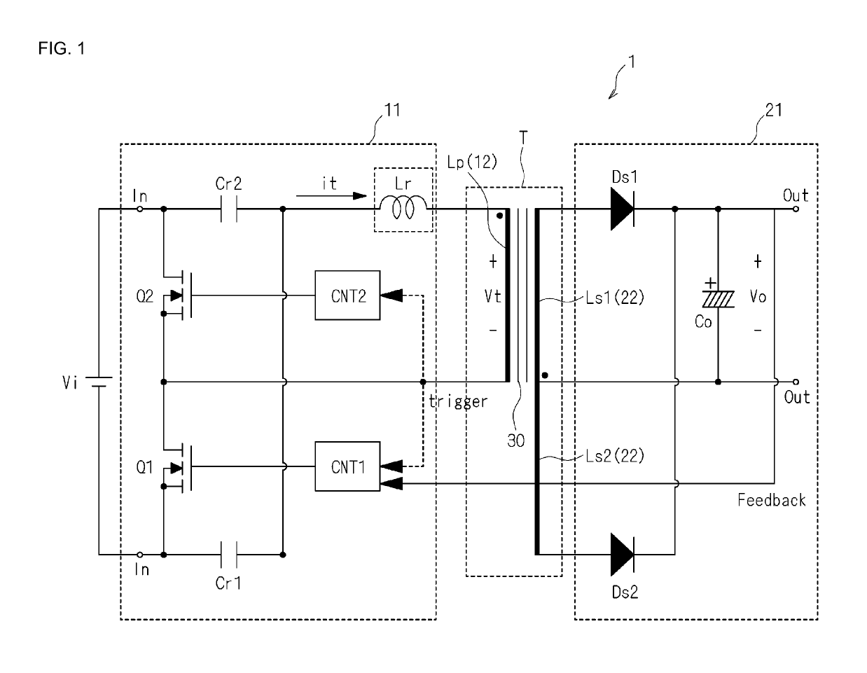

FIG. 1 is a circuit diagram illustrating the circuit structure of an isolated switching power supply apparatus according to a first preferred embodiment of the present invention. An isolated switching power supply apparatus 1 illustrated in FIG. 1 includes a primary-side circuit 11, a secondary-side circuit 21, and a transformer T.

The transformer T includes a primary winding 12 that includes a winding Lp, a secondary winding 22 that includes windings Ls1 and Ls2, and a core 30.

The primary-side circuit 11 includes switching elements Q1 and Q2, and is a circuit that supplies input power from an input terminal In to the primary winding 12 by controlling on/off of the switching elements Q1 and Q2. Specifically, the primary-side circuit 11 includes the switching elements Q1 and Q2 and capacitors Cr1 and Cr2. The switching element Q1 and the capacitor Cr1 are connected to the winding Lp of the transformer T so as to define a closed loop. The switching element Q2 and the capacitor Cr2 are connected in series with the switching element Q1 and connected to the winding Lp of the transformer T so as to define another closed loop. Furthermore, a first switching control circuit CNT1 that controls on/off of the switching element Q1 is connected to the switching element Q1. A second switching control circuit CNT2 that controls on/off of the switching element Q2 is connected to the switching element Q2. A power source Vi is connected to input terminals In of the primary-side circuit 11.

The secondary-side circuit 21 is a circuit that outputs output power resulting from power conversion performed by the transformer T, from the secondary winding 22 to an output terminal Out. Specifically, the secondary-side circuit 21 includes rectifier diodes Ds1 and Ds2 and a smoothing capacitor Co. The rectifier diodes Ds1 and Ds2 are connected to the windings Ls1 and Ls2 of the transformer T, respectively. The smoothing capacitor Co is connected between the rectifier diodes Ds1 and Ds2 and output terminals Out. Note that the rectifier diodes Ds1 and Ds2 and the smoothing capacitor Co constitute a rectifying-and-smoothing circuit.

A trigger signal is input to the first switching control circuit CNT1 at a timing at which a transformer voltage Vt applied across the winding Lp of the transformer T rises. Moreover, an output voltage Vo of the output terminal Out is detected and a feedback signal is input to the first switching control circuit CNT1, the feedback signal being used to determine a period during which the switching element Q1 is in an ON state so that the detected output voltage Vo becomes a predetermined voltage.

A trigger signal is input to the second switching control circuit CNT2 at a timing at which the transformer voltage Vt applied across the winding Lp of the transformer T falls. Moreover, the transformer voltage Vt applied across the winding Lp of the transformer T is detected and a control signal is input to the second switching control circuit CNT2, the control signal being used to determine a period during which the switching element Q2 is in an ON state so that the detected transformer voltage Vt becomes 0 V. Note that the switching elements Q1 and Q2 may be controlled by a control circuit such as a control IC that outputs a signal to complementarily switch on/off of the switching elements Q1 and Q2. Moreover, the circuit structure of the isolated switching power supply apparatus 1 is the same as the circuit structure of a general current resonant type half-bridge converter. The operation of the isolated switching power supply apparatus 1 is also the same as the operation of a general current resonant type half-bridge converter. Thus, detailed description about the operation of the isolated switching power supply apparatus 1 will be omitted.

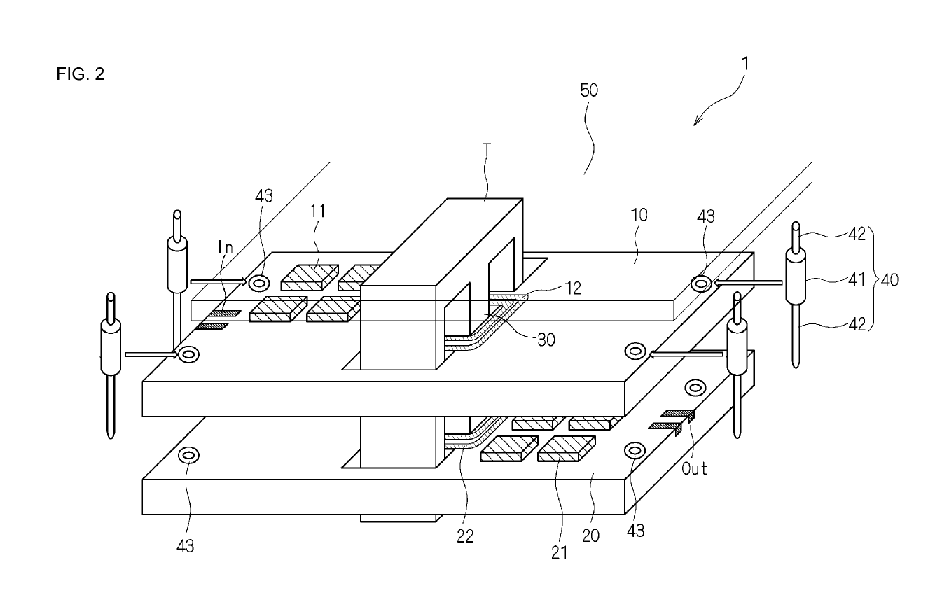

Next, FIG. 2 is a schematic diagram illustrating the structure of the isolated switching power supply apparatus 1 according to the first preferred embodiment of the present invention. The isolated switching power supply apparatus 1 illustrated in FIG. 2 includes a first circuit board 10 and a second circuit board 20. The first circuit board 10, to which the primary winding 12 is connected, includes the primary-side circuit 11 and the input terminals In. The second circuit board 20, to which the secondary winding 22 is connected, includes the secondary-side circuit 21 and the output terminals Out. Moreover, in the isolated switching power supply apparatus 1, the first circuit board 10 and the second circuit board 20 are stacked in a multilayer manner and the primary winding 12 and the secondary winding 22 are arranged around the core 30 that extends through the first circuit board 10 and the second circuit board 20. That is, power is transferred between the first circuit board 10 and the second circuit board 20 via the core 30; however, the first circuit board 10 and the second circuit board 20 are electrically isolated from each other.

The primary winding 12 is defined by a coil pattern that is preferably formed by performing patterning on a conducting film provided on the first circuit board 10. Similarly, the secondary winding 22 is defined by a coil pattern that is preferably formed by performing patterning on a conducting film provided on the second circuit board 20. In the case where the primary winding 12 and the secondary winding 22 are defined by coil patterns, there is no need to mount an additional coil as a winding on the first circuit board 10 or the second circuit board 20.

The distance between the first circuit board 10 and the second circuit board 20, which are stacked in the multilayer manner, may be defined by spacers 40. A spacer 40 includes a spacer portion 41 and a shaft portion 42 that extends from the both ends of the spacer portion 41 and is fixed by the first circuit board 10 and the second circuit board 20 by inserting the shaft portion 42 into holes 43 provided in the first circuit board 10 and the second circuit board 20. The distance between the first circuit board 10 and the second circuit board 20, which are stacked in the multilayer manner, may be easily changed by changing the height of spacer portions 41.

The distance between the primary winding 12 and the secondary winding 22 is changed by changing the distance between the first circuit board 10 and the second circuit board 20, which are stacked in the multilayer manner. Consequently, the amount of leakage inductance occurring in the transformer T is changed. There is no need to mount an additional inductor on the first circuit board 10 since the leakage inductance is used as the inductance of an inductor Lr illustrated in FIG. 1 and connected in series with the primary winding 12. Thus, the number of components used may be reduced. Moreover, the amount of leakage inductance occurring in the transformer T may be changed. Thus, in order to make leakage inductance occur in the transformer T, there is no need to specially design the primary winding 12 or the secondary winding 22 such that the size of the coil pattern is increased, the coil pattern is made complex, or the like. Note that the leakage inductance occurring in the transformer T does not have to be used as the inductance of the inductor Lr connected in series with the primary winding 12 and may be used as the inductance of an inductor connected in series with the secondary winding 22.

There is no need to electrically connect the first circuit board 10 with the second circuit board 20 by the spacers 40. Note that, in the case where a circuit different from the primary-side circuit 11 is located on the first circuit board 10 and a circuit different from the secondary-side circuit 21 is located on the second circuit board 20 and in the case where these circuits different from the primary-side circuit 11 and secondary-side circuit 21 are electrically connected with each other, the first circuit board 10 may be electrically connected with the second circuit board 20 by using spacers 40 made of a conductive material. Moreover, a spacer 40 may be connected to an input terminal In of the first circuit board 10 and function as an input terminal, or may be connected to an output terminal Out of the second circuit board 20 and function as an output terminal. In the case where the isolated switching power supply apparatus 1 includes a plurality of spacers 40, one of the spacers 40 may be connected to the input terminal In and another one of the spacers 40 may be connected to the output terminal Out. In the case where a spacer 40 functions as the input terminal, the spacer 40 is electrically isolated from the second circuit board 20. In the case where a spacer 40 functions as the output terminal, the spacer 40 is electrically isolated from the first circuit board 10.

A heat sink 50 is provided in the isolated switching power supply apparatus 1 in order to extract heat from the transformer T. Note that the heat sink 50 is not limited to the one having a structure illustrated in FIG. 2 and does not have to be at a position in contact with the transformer T. For example, the heat sink 50 may contact the transformer T on the side (on the bottom-surface side in the drawing) of the second circuit board 20.

As described above, the isolated switching power supply apparatus 1 according to the first preferred embodiment of the present invention includes the first circuit board 10 and the second circuit board 20. The first circuit board 10, to which the primary winding 12 is connected, includes the primary-side circuit 11 and the input terminals In. The second circuit board 20, to which the secondary winding 22 is connected, includes the secondary-side circuit 21 and the output terminals Out. The first circuit board 10 and the second circuit board 20 are stacked in the multilayer manner. The primary winding 12 and the secondary winding 22 are arranged around the core 30 that extends through the first circuit board 10 and the second circuit board 20. Thus, there is no need to redundantly provide identical circuits on both the first circuit board 10 and the second circuit board 20, and consequently, the manufacturing cost may be reduced. Moreover, since the input terminals In are provided on the first circuit board 10 and the output terminals Out are provided on the second circuit board 20, a common terminal that connects patterns formed on the first circuit board 10 and the second circuit board 20 is not necessary. It is not necessary to make a large current flow through a common terminal, and consequently, current loss may be reduced in the isolated switching power supply apparatus 1.

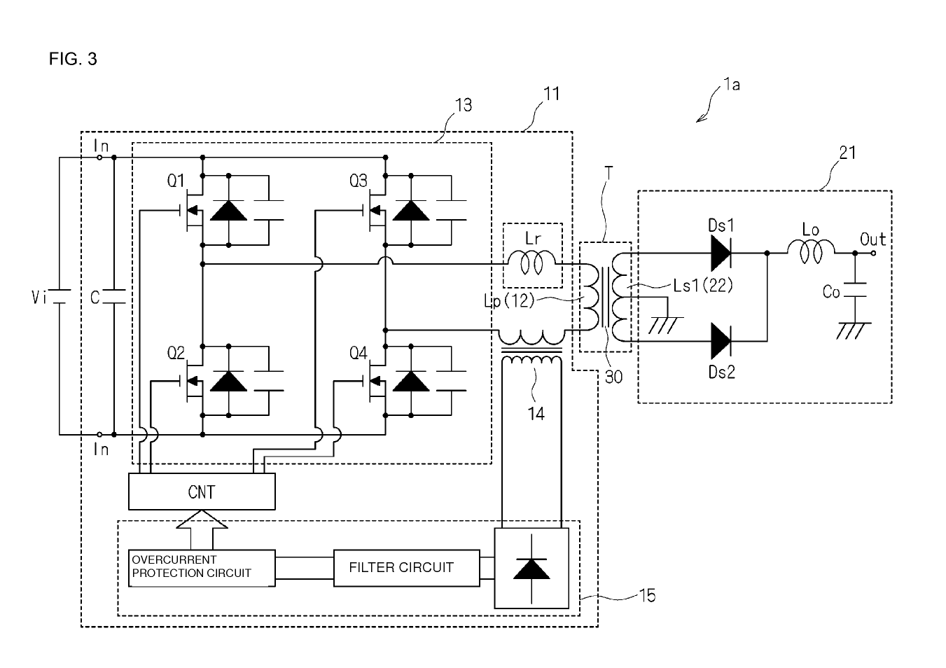

Note that, the primary winding 12, which is defined by a coil pattern, may be provided in a single layer or through multiple layers of the first circuit board 10, and the secondary winding 22, which is defined by a coil pattern, may be provided in a single layer or through multiple layers of the second circuit board 20. Moreover, the primary winding 12 and the secondary winding 22 may be a coil such as a winding arranged around a bobbin or an edgewise coil. Moreover, the circuit structure of the isolated switching power supply apparatus 1 does not have to be the same as the circuit configuration of a current resonant type half-bridge converter. The circuit structure of the isolated switching power supply apparatus 1 may be the same as the circuit structure of a zero-voltage switching (ZVS) converter, the circuit structure of a phase-shifted full bridge converter, or the like. FIG. 3 is a circuit diagram illustrating another circuit structure of the isolated switching power supply apparatus 1 according to the first preferred embodiment of the present invention. An isolated switching power supply apparatus la illustrated in FIG. 3 includes the primary-side circuit 11, the secondary-side circuit 21, and the transformer T. Note that the circuit structure of the isolated switching power supply apparatus la is the same as the circuit structure of a phase-shifted full bridge converter.

The transformer T includes the primary winding 12 that includes the winding Lp, the secondary winding 22 that contains the winding Ls1, and the core 30.

The primary-side circuit 11 includes a full bridge circuit 13 that includes switching elements Q1 to Q4, and is a circuit that supplies input power from an input terminal In to the primary winding 12 by controlling on/off of the switching elements Q1 to Q4 of the full bridge circuit 13. Specifically, in the primary-side circuit 11, each of the switching elements Q1 to Q4 is connected in parallel with a respective diode and a respective capacitor that are connected in parallel with each other and a switching control circuit CNT that controls on/off of the switching elements Q1 to Q4 is connected to the switching elements Q1 to Q4. The power source Vi is connected to the input terminals In of the primary-side circuit 11, and an input smoothing capacitor C is connected between the input terminals In and the full bridge circuit 13. Furthermore, the primary-side circuit 11 includes a current transformer 14 for current detection and a control circuit 15 that controls operation of the switching control circuit CNT in accordance with a current value detected by the current transformer 14 for current detection. The control circuit 15 includes a diode, a filter circuit, and an overcurrent protection circuit, the diode detecting a current value.

The secondary-side circuit 21 is a circuit that outputs output power resulting from power conversion performed by the transformer T, from the secondary winding 22 to an output terminal Out. Specifically, the secondary-side circuit 21 includes the rectifier diodes Ds1 and Ds2, a choke coil Lo, and the smoothing capacitor Co. The rectifier diodes Ds1 and Ds2 are connected to the winding Ls1 of the transformer T. The choke coil Lo and the smoothing capacitor Co are connected between the rectifier diodes Ds1 and Ds2 and the output terminal Out. Note that the rectifier diodes Ds1 and Ds2, the choke coil Lo, and the smoothing capacitor Co constitute a rectifying-and-smoothing circuit. Note that, the operation of the isolated switching power supply apparatus la is the same as the operation of a general phase-shifted full bridge converter. Thus, detailed description about the operation of the isolated switching power supply apparatus la will be omitted.

### Second Preferred Embodiment

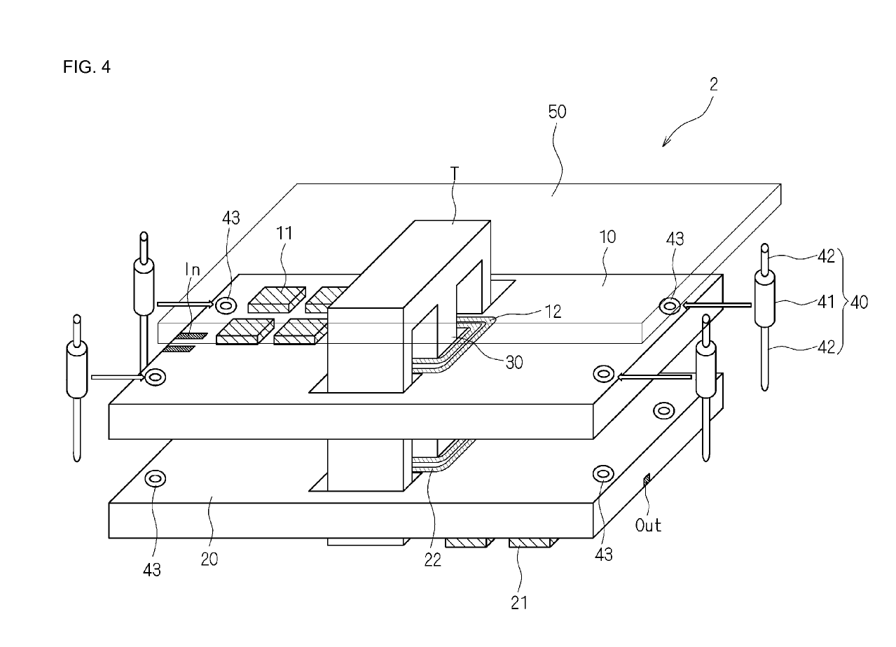

FIG. 4 is a schematic diagram illustrating the structure of an isolated switching power supply apparatus according to a second preferred embodiment of the present invention. The circuit structure of an isolated switching power supply apparatus 2 illustrated in FIG. 4 is preferably the same or substantially the same as the circuit structure of the isolated switching power supply apparatus 1 and that of the isolated switching power supply apparatus la according to the first preferred embodiment. Thus, detailed description about the circuit structure of the isolated switching power supply apparatus 2 will be omitted.

The isolated switching power supply apparatus 2 includes the first circuit board 10 and the second circuit board 20. The first circuit board 10, to which the primary winding 12 is connected, includes the primary-side circuit 11 and the input terminals In. The second circuit board 20, to which the secondary winding 22 is connected, includes the secondary-side circuit 21 and an output terminal Out. Moreover, in the isolated switching power supply apparatus 2, the first circuit board 10 and the second circuit board 20 are stacked in a multilayer manner, and the primary winding 12 and the secondary winding 22 are arranged around the core 30 that extends through the first circuit board 10 and the second circuit board 20. That is, power is transferred between the first circuit board 10 and the second circuit board 20 via the core 30; however, the first circuit board 10 and the second circuit board 20 are electrically isolated from each other.

Note that components of the primary-side circuit 11 are arranged on a surface, which is the farthest surface from the surface facing the second circuit board 20, of the first circuit board 10. Components of the secondary-side circuit 21 are arranged on a surface, which is the farthest surface from the surface facing the first circuit board 10, of the second circuit board 20. Thus, the first circuit board 10 may be arranged to approach the second circuit board 20 at a position where the first circuit board 10 contacts the second circuit board 20. Consequently, the distance between the first circuit board 10 and the second circuit board 20, which are stacked in the multilayer manner, may be changed so as to be in a wider range. As a result, the amount of leakage inductance occurring in the transformer T may be changed in a wider range. Note that, in the case where the first circuit board 10 and the second circuit board 20 are in contact, the strongest coupling occurs due to the mutual inductance between the primary winding 12 and the secondary winding 22 and the amount of leakage inductance occurring in the transformer T is smallest.

The primary-side circuit 11 does not have to be provided on the left-side portion of the first circuit board 10 in the drawing and the secondary-side circuit 21 does not have to be provided on the right-side portion of the second circuit board 20 in the drawing. The primary-side circuit 11 may be provided on either the left-side or right-side portion of the first circuit board 10 in the drawing and the secondary-side circuit 21 may be provided on either the left-side or right-side portion of the second circuit board 20 in the drawing. Moreover, the shape of the first circuit board 10 and the shape of the second circuit board 20 do not have to be a rectangular or substantially rectangular shape that extends from both sides of the transformer T and may be a rectangular or substantially rectangular shape that extends only from one side of the transformer T or the like.

As described above, in the isolated switching power supply apparatus 2 according to the second preferred embodiment of the present invention, the components of the primary-side circuit 11 are arranged on the surface, which is the farthest surface from the surface facing the second circuit board 20, of the first circuit board 10 and the components of the secondary-side circuit 21 are arranged on the surface, which is the farthest surface from the surface facing the first circuit board 10, of the second circuit board 20. Thus, the first circuit board 10 may be caused to approach the second circuit board 20 at a position where the first circuit board 10 contacts the second circuit board 20. Consequently, the distance between the first circuit board 10 and the second circuit board 20, which are stacked in the multilayer manner, may be changed in a wider range. Thus, the amount of leakage inductance occurring in the transformer T may be changed so as to be in a wider range.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

1. (canceled)

2. An isolated switching power supply apparatus comprising:
a transformer that includes a primary winding, a secondary winding, and a core;
a primary-side circuit that includes at least a switching element and supplies input power from an input terminal to the primary winding by controlling on/off of the switching element;
a secondary-side circuit that is electrically isolated from the primary-side circuit and outputs, from the secondary winding to an output terminal, output power resulting from power conversion performed by the transformer;
a first circuit board to which the primary winding is connected and that includes the primary-side circuit and the input terminal; and
a second circuit board to which the secondary winding is connected and that includes the secondary-side circuit and the output terminal; wherein
the first circuit board and the second circuit board are stacked in a multilayer manner, and the core extends through the first circuit board and the second circuit board such that both the primary winding and the secondary winding are arranged around the core.

3. The isolated switching power supply apparatus according to claim 2, wherein the first and second circuit boards are arranged such that a distance between the primary winding and the secondary winding is changed by changing a distance between the first circuit board and the second circuit board so as to change an amount of leakage inductance occurring in the transformer, and
the leakage inductance occurring in the transformer is used as an inductance of an inductor connected in series with the primary winding or the secondary winding.

4. The isolated switching power supply apparatus according to claim 2, further comprising a spacer that defines a distance between the first circuit board and the second circuit board.

5. The isolated switching power supply apparatus according to claim 2, wherein the primary winding includes a coil pattern on the first circuit board and the secondary winding includes a coil pattern on the second circuit board.

6. The isolated switching power supply apparatus according to claim 2, wherein
components of the primary-side circuit are arranged on a surface of the first circuit board that is a farthest surface from a surface facing the second circuit board; and
components of the secondary-side circuit are arranged on a surface of the second circuit board that is a farthest surface from the surface facing the first circuit board.

7. The isolated switching power supply apparatus according to claim 2, wherein the primary winding circuit includes at least two switching elements and at least two capacitors.

8. The isolated switching power supply apparatus according to claim 2, wherein the secondary winding circuit includes at least two rectifier diodes and a smoothing capacitor arranged to define a rectifying-and-smoothing circuit.

9. The isolated switching power supply apparatus according to claim 4, wherein the spacer includes a spacer portion and a shaft portion that extends from both ends of the spacer portion.

10. The isolated switching power supply apparatus according to claim 4, wherein the spacer is made of conductive material.

11. The isolated switching power supply apparatus according to claim 4, wherein the spacer defines the input terminal and is electrically isolated from the second circuit board.

12. The isolated switching power supply apparatus according to claim 4, wherein the spacer defines the output terminal and is electrically isolated from the first circuit board.

13. The isolated switching power supply apparatus according to claim 2, further comprising a plurality of spacers that define a distance between the first circuit board and the second circuit board wherein the spacer is made of conductive material.

14. The isolated switching power supply apparatus according to claim 13, wherein the spacers are made of conductive material.

15. The isolated switching power supply apparatus according to claim 13, wherein one of the spacers is connected to the input terminal and another one of the spaces is connected to the output terminal.

16. The isolated switching power supply apparatus according to claim 2, further comprising a heat sink arranged to extract heat from the transformer.

17. The isolated switching power supply apparatus according to claim 2, wherein the primary winding is a coil pattern defined by a single layer of the first circuit board.

18. The isolated switching power supply apparatus according to claim 2, wherein the primary winding is a coil pattern defined by a plurality of layers of the first circuit board.

19. The isolated switching power supply apparatus according to claim 2, wherein the secondary winding is a coil pattern defined by a single layer of the second circuit board.

20. The isolated switching power supply apparatus according to claim 2, wherein the secondary winding is a coil pattern defined by a plurality of layers of the second circuit board.

21. The isolated switching power supply apparatus according to claim 2, wherein each of the primary winding and the secondary winding is a coil arranged around a bobbin or an edgewise coil.
